(19) United States
(12) Patent Application Publication
(10) Pub. No.: US 2006/0088750 A1
(43) Pub. Date: Apr. 27, 2006

(54) Proton-conducting polymer material, and solid electrolyte membrane, electrochemical cell and fuel cell therewith

(76) Inventors: Tomoki Nobuta, Miyagi (JP); Toshihiko Nishiyama, Miyagi (JP); Naoki Takahashi, Miyagi (JP)

Correspondence Address: KNOBBE MARTENS OLSON & BEAR LLP, 2040 MAIN STREET, FOURTEENTH FLOOR, IRVINE, CA, 92614, US

(21) Appl. No.: 11/255,552

(22) Filed: Oct. 21, 2005

(30) Foreign Application Priority Data
Oct. 22, 2004 (JP) 2004-308139

(51) Int. Cl. H01M 8/10; C08J 5/20; H01M 4/86

(52) U.S. Cl. 429/33; 521/25; 429/42; 429/314

(57) ABSTRACT

This invention relates to a proton-conducting polymer material comprising a quinoxaline-based compound structure, an imidazole-based compound structure and a proton-donating substituent, and a solid electrolyte membrane, an electrochemical cell and a fuel cell therewith.

### BACKGROUND OF THE INVENTION

1. Field of the Invention

This invention relates to an electrochemical cell such as a secondary battery, an electric double-layer capacitor, a redox capacitor and a condenser, and fuel cell, as well as a proton-conducting polymer material therefor and a solid electrolyte membrane therewith.

2. Description of the Related Art

Conventional electrolytes, for example, as an electrolyte membrane for a solid polymer type fuel cell, include proton-conducting polymer type solid electrolyte membranes such as Nafion® (a perfluorosulfonic acid type ion-exchange membrane) (See, for example, JP7-22034A and JP7-326363A).

Furthermore, JP7-320780A has disclosed a solid electrolyte for a lithium secondary battery, which consists of a complex of a polymer such as polyimidazole and an electrolyte salt. The complex has been prepared by admixing a polymer solution with an electrolyte salt and drying the mixture.

JP2003-242833A has disclosed a proton-conducting solid electrolyte comprising a polymer having a quinoxaline structure and an acidic compound, and a solid electrolyte membrane therewith, as well as a fuel cell, an electric double-layer condenser and an electrochromic device with the electrolyte membrane. The proton-conducting solid electrolyte comprises an acidic compound (an inorganic acid, an organic acid, an acidic monomer or an acidic polymer) capable of donating a proton with a polymer having a quinoxaline structure in order to achieve a highly proton-conducting solid polymer electrolyte membrane. For example, there has been described in one of Examples a secondary battery comprising an electrolyte membrane prepared by immersing polyphenylquinoxaline in an acidic monomer (para-styrenesulfonic acid) solution and polymerizing the acidic monomer; 20% aqueous sulfuric acid solution as an electrolytic solution; a polyaniline electrode and a polypyridine-2,5-diyl electrode. There has been further described a fuel cell comprising an electrolyte membrane prepared by immersing polyphenyl quinoxaline in an acidic monomer (vinylsulfonic acid) solution and polymerizing the acidic monomer.

### SUMMARY OF THE INVENTION

An objective of this invention is to provide a proton-conducting polymer material and a solid electrolyte membrane exhibiting improved proton conductivity and durability. Another objective of this invention is to provide an electrochemical cell and a fuel cell which exhibit excellent current properties and are highly reliable.

After intense investigation for achieving the above objectives, we have finally found that a proton-conducting polymer material having a quinoxaline structure, an imidazole structure and a proton-donating substituent exhibits higher proton conductivity and excellent durability even at an elevated temperature, achieving this invention.

Briefly, according to an aspect of this invention, there is provided a proton-conducting polymer material comprising a quinoxaline-based compound structure, an imidazole-based compound structure and a proton-donating substituent.

According to another aspect of this invention, there is provided the proton-conducting polymer material as described above, wherein the quinoxaline-based compound structure is a quinoxaline structure represented by general formula (1):

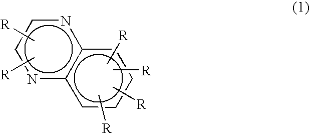

wherein at least one of Rs is attached to a principal chain or a side chain or at least two of Rs forms the principal chain, and the remaining Rs independently represent the proton-donating substituent, a hydrogen atom, a hydroxyl group, an amino group, a nitro group, a phenyl group, a vinyl group, a halogen atom, an acyl group, a cyano group, a trifluoromethyl group, an alkoxyl group, a sulfonic acid group, a trifluoromethylthio group, a carboxyl group, a carboxylate group, a sulfonate group, an alkyl group having 1 to 20 carbon atoms optionally substituted with any of the above substituents, an alkenyl group having 2 to 20 carbon atoms optionally substituted with any of the above substituents, an aryl group having 6 to 20 carbon atoms optionally substituted with any of the above substituents or a heterocyclic-compound residue.

According to another aspect of this invention, there is provided the proton-conducting polymer material as described above, wherein the quinoxaline-based compound structure is a quinoxaline structure unit represented by general formula (2):

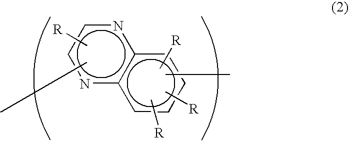

wherein Rs independently represent the above proton-donating substituent, a hydrogen atom, a hydroxyl group, an amino group, a nitro group, a phenyl group, a vinyl group, a halogen atom, an acyl group, a cyano group, a trifluoromethyl group, an alkoxyl group, a sulfonic acid group, a trifluoromethylthio group, a carboxyl group, a carboxylate group, a sulfonate group, an alkyl group having 1 to 20 carbon atoms optionally substituted with any of the above substituents, an alkenyl having 2 to 20 carbon atoms optionally substituted with any of the above substituents, an aryl group having 6 to 20 carbon atoms optionally substituted with any of the above substituents or a heterocyclic-compound residue.

According to another aspect of this invention, there is provided the proton-conducting polymer material as described above, comprising a polymer which comprises a unit having the quinoxaline-based compound structure, a unit having the imidazole-based compound structure, and a proton-donating substituent attached to at least one of these units as the proton-donating substituent where a quinoxaline fused ring in the quinoxaline-based compound structure is a constituent of a principal chain of the polymer.

According to another aspect of this invention, there is provided the proton-conducting polymer material as described above, wherein the proton-donating substituent is at least attached to an imidazole ring nitrogen in the imidazole-based compound structure.

According to another aspect of this invention, there is provided the proton-conducting polymer material as described above, comprising a block copolymer which comprises a chain of units having the quinoxaline-based compound structure, a chain of units having the imidazole-based compound structure and a proton-donating substituent attached to at least one of these units as the proton-donating substituent.

According to another aspect of this invention, there is provided the proton-conducting polymer material as described above, comprising a polymer where the imidazole-based compound structure or a side chain having the imidazole-based compound structure is attached to the principal chain having a unit having the quinoxaline-based compound structure.

According to another aspect of this invention, there is provided the proton-conducting polymer material as described above, comprising a polymer which comprises a unit having the quinoxaline-based compound structure, a polymer which comprises a unit having the imidazole-based compound structure and a proton-donating substituent attached to at least one of these polymers as the proton-donating substituent.

According to another aspect of this invention, there is provided the proton-conducting polymer material as described above, wherein the imidazole-based compound structure has a benzimidazole or benzobisimidazole moiety.

According to another aspect of this invention, there is provided the proton-conducting polymer material as described above, wherein the imidazole-based compound structure comprises at least one selected from the group consisting of a unit having a benzimidazole moiety represented by one of general formulas (3) to (5), a unit having a benzobisimidazole moiety represented by (6) and a vinylimidazole unit represented by general formula (7):

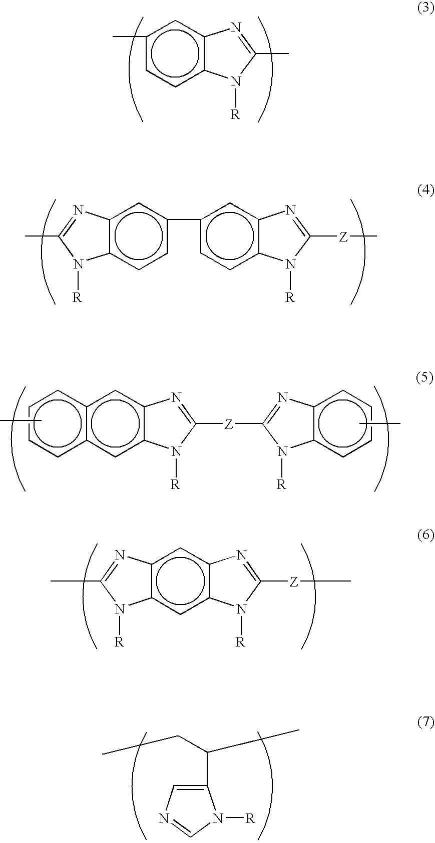

wherein Rs independently represent the above proton-donating substituent, a hydrogen atom, a hydroxyl group, an amino group, a nitro group, a phenyl group, a vinyl group, a halogen atom, an acyl group, a cyano group, a trifluoromethyl group, an alkoxyl group, a sulfonic acid group, a trifluoromethylthio group, a carboxyl group, a carboxylate group, a sulfonate group, an alkyl group having 1 to 20 carbon atoms optionally substituted with any of the above substituents, an alkenyl group having 2 to 20 carbon atoms optionally substituted with any of the above substituents, an aryl group having 6 to 20 carbon atoms optionally substituted with any of the above substituents or a heterocyclic-compound residue; and Z represents an arylene group optionally substituted with any of the above substituents.

According to another aspect of this invention, there is provided the proton-conducting polymer material as described above, comprising a polymer which comprises a unit having a quinoxaline structure, an imidazole structure and a proton-donating substituent, represented by general formula (8):

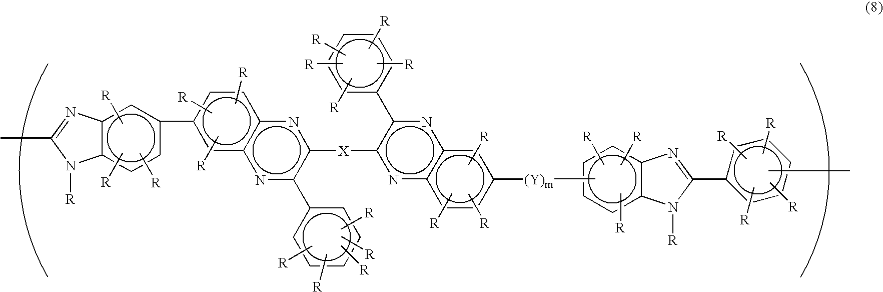

wherein at least one of Rs represents a proton-donating substituent and the remaining Rs independently represent a hydrogen atom, a hydroxyl group, an amino group, a nitro group, a phenyl group, a vinyl group, a halogen atom, a acyl group, a cyano group, a trifluoromethyl group, an alkoxyl group, a sulfonic acid group, a trifluoromethylthio group, a carboxyl group, a carboxylate group, a sulfonate group, an alkyl group having 1 to 20 carbon atoms optionally substituted with any of the above substituents, an alkenyl group having 2 to 20 carbon atoms optionally substituted with any of the above substituents, an aryl group having 6 to 20 carbon atoms optionally substituted with any of the above substituents or a heterocyclic-compound residue; X represents an optionally substituted arylene group; Ys independently represent a heteroatom, a sulfonyl group, a methylene group, an optionally substituted alkylene group having 2 to 20 carbon atoms and an optionally substituted arylene group having 6 to 20 carbon atoms; and m represents an integer of 0 to 5.

According to another aspect of this invention, there is provided the proton-conducting polymer material as described above, wherein the proton-donating substituent is a sulfonic acid group or a substituent having a sulfonic acid group.

According to another aspect of this invention, there is provided an electrode-active material comprising the proton-conducting polymer material as described above.

According to another aspect of this invention, there is provided a solid electrolyte comprising the proton-conducting polymer material as described above.

According to another aspect of this invention, there is provided the solid electrolyte as described above, further comprising an acidic compound.

According to another aspect of this invention, there is provided the solid electrolyte as described above, wherein the acidic compound is at least one selected from the group consisting of sulfuric acid, hydrochloric acid, nitric acid, acetic acid, boric acid, tetrafluoroboric acid, phosphoric acid, hexafluorophosphoric acid, propionic acid, fluoropropionic acid, butyric acid and fluorobutyric acid.

According to another aspect of this invention, there is provided the solid electrolyte as described above, wherein the acidic compound is at least one selected from the group consisting of a monomer of sulfonic acid-based compound, a monomer of carboxylic acid-based compound and a monomer of phosphoric acid-based compound and polymers of the monomers.

According to another aspect of this invention, there is provided a solid electrolyte membrane consisting of the solid electrolyte as described above.

According to another aspect of this invention, there is provided the solid electrolyte membrane as described above, wherein its thickness is 10 to 200 μm.

According to another aspect of this invention, there is provided an electrochemical cell comprising the proton-conducting polymer material as described above as an electrode-active material.

According to another aspect of this invention, there is provided an electrochemical cell comprising a pair of electrodes and the solid electrolyte membrane as described above sandwiched between these electrodes.

According to another aspect of this invention, there is provided the electrochemical cell as described above, wherein the electrolyte contains a proton source and the electrochemical cell can operate such that protons alone act as a charge carrier in a redox reaction associated with charge/discharge.

According to another aspect of this invention, there is provide a fuel cell comprising a fuel electrode, an air electrode and the solid electrolyte membrane as described above between the electrodes.

A polyquinoxaline is a highly heat-resistant polymer, whose decomposition temperature is 500° C. or higher under the atmospheric air as measured by TG method (thermogravimetry). Furthermore, its quinoxaline moiety has high proton affinity and exhibits good redox resistance under an acidic condition. On the other hand, it is well-known that in an imidazole-based compound, the imidazole moiety itself is proton-conductive under an acidic condition. Among imidazole-based compounds, a polybenzimidazole exhibits heat resistance comparable to a polyquinoxaline as actually determined.

A proton-conducting polymer material and a solid electrolyte membrane according to this invention have a quinoxaline structure, which exhibits good heat and redox resistance and has proton affinity as described, and such a proton-conductive imidazole structure. It can, therefore, realize higher proton conductivity and good durability even under an acidic atmosphere, i.e., higher reliability. Furthermore, it comprises a proton-donating substituent, resulting in excellent proton conductivity.

In preparing a proton-conducting polymer material and a solid electrolyte membrane according to this invention, polymerization style can be appropriately selected to form, for example, a random structure, a block structure or a graft structure. A composition of the quinoxaline structure unit and the imidazole structure unit can be appropriately determined to achieve desired properties, depending on its use environment and application.

After preparing a polymer, a proton-donating substituent can be readily introduced in an imidazole ring. Thus, a polymer having an adequate molecular weight can be prepared without an adverse effect of reducing polymerizability by a sulfonic acid group attached to a starting monomer during polymerization. It can, therefore, result in an electrolyte membrane exhibiting excellent heat resistance and strength.

Furthermore, during or after the preparation, binding style of a sulfonic acid group and a sulfonation degree can be controlled to provide a proton-conducting polymer material and a solid electrolyte membrane which can keep good proton conductivity even at an elevated temperature for a long period.

A proton-conducting polymer material and a solid electrolyte membrane according to this invention can be used to provide an electrochemical cell such as a secondary battery, an electric double-layer capacitor, a redox capacitor and a condenser, and a fuel cell exhibiting excellent current properties and reliability.

### BRIEF DESCRIPTION OF THE DRAWINGS

FIG. 1 shows a cyclic voltammogram from a CV test in Example 1 of this invention.

FIG. 2 is a schematic cross-sectional view of an electrochemical cell of this invention.

FIG. 3 is a schematic cross-sectional view of a fuel cell of this invention.

### DETAILED DESCRIPTION OF PREFERRED EMBODIMENTS

A proton-conducting polymer material according to this invention comprises a quinoxaline-based compound structure, an imidazole-based compound structure and a proton-donating substituent.

The proton-conducting polymer material of this invention may comprise a proton-conducting polymer having, for example, the following chain structure. A proton-donating substituent is attached to at least one of a unit having a quinoxaline-based compound moiety and a unit having an imidazole-based compound moiety.

(a) a random copolymer structure comprising a unit having a quinoxaline-based compound moiety and a unit having an imidazole-based compound moiety.

(b) a block structure in which a chain of units having a quinoxaline-based compound moiety and a chain of units having an imidazole-based compound moiety are combined.

(c) a block structure in which a random copolymer chain comprising a unit having a quinoxaline-based compound moiety and a unit having an imidazole-based compound moiety, a chain of units having a quinoxaline-based compound moiety, and a chain of units having an imidazole-based compound moiety are combined.

(d) a graft structure in which a side chain (branched chain) having an imidazole-based compound moiety or an imidazole-based compound is attached to a principal polymer (principal chain) comprising a unit having a quinoxaline-based compound moiety.

(e) a graft structure in which a side chain (branched chain) having an imidazole-based compound moiety or an imidazole-based compound is attached to a principal polymer (principal chain) consisting of a block polymer comprising a chain of units having a quinoxaline-based compound moiety and a chain of units having an imidazole-based compound moiety.

(f) a graft structure in which a side chain (branched chain) having an imidazole-based compound moiety or an imidazole-based compound is attached to a principal polymer (principal chain) consisting of a block polymer comprising a random copolymer chain which comprises a unit having a quinoxaline-based compound moiety and a unit having an imidazole-based compound moiety, a chain of units having a quinoxaline-based compound moiety and a chain of units having an imidazole-based compound moiety.

A proton-conducting polymer material according to this invention may comprise a polymer comprising a unit having a quinoxaline-based compound moiety, a polymer comprising a unit having an imidazole-based compound moiety, and a proton-donating substituent attached to at least one of these polymers.

Particularly, in the light of electric properties such as discharge capacity, the polymer in the proton-conducting polymer material of this invention is desirably a proton-conducting polymer comprising a quinoxaline-based compound structure, an imidazole-based compound structure and a proton-donating substituent.

The proton-conducting polymer in this invention preferably has the quinoxaline structure represented by general formula (1). Although the quinoxaline structure may have a configuration that a part of the structure is attached to a principal chain or a side chain, the principal chain contains the quinoxaline structure as its part as shown in general formula (2) in the light of achieving desired properties.

Examples of a proton-donating substituent include sulfonic acid group and carboxyl group. It is preferably sulfonic acid group or a substituent having a sulfonic acid group.

Examples of a halogen atom for R in each general formula herein include fluorine, chlorine, bromine and iodine atoms. Examples of an alkyl group for R herein include methyl, ethyl, propyl, isopropyl, n-butyl, s-butyl, isobutyl, t-butyl, n-pentyl, n-hexyl, n-heptyl and n-octyl groups. An acyl group for R herein is a substituent represented by —COX, wherein X may be selected from the above alkyl groups. An alkoxyl group for R herein is a substituent represented by —OX, wherein X may be selected from the above alkyl groups. An alkyl moiety in an ester group in a carboxylate group or a sulfonate group for R herein may be selected from the above alkyl groups. Examples of an alkenyl group for R herein include ethenyl (vinyl), 2-propenyl (allyl), 1,3-butadienyl and 4-methoxy-2-butenyl groups. Examples of aryl for R herein include phenyl, naphthyl and anthryl groups. A heterocyclic-compound residue for R herein may be a 3- to 10-membered ring group having 2 to 20 carbon atoms and 1 to 5 heteroatoms. Examples of heteroatom include oxygen, sulfur and nitrogen atoms.

There will be described preferred embodiments of this invention with reference to specific examples.

General formulas (9), (10) and (11) are examples of a repeating unit having sulfonic acid group as an ion-exchange group in proton-donating substituent in a proton-conducting polymer.

Herein, the number of sulfonic acid group per unit is defined as a “sulfonation degree”. For example, general formula (9) has a sulfonation degree of 2.

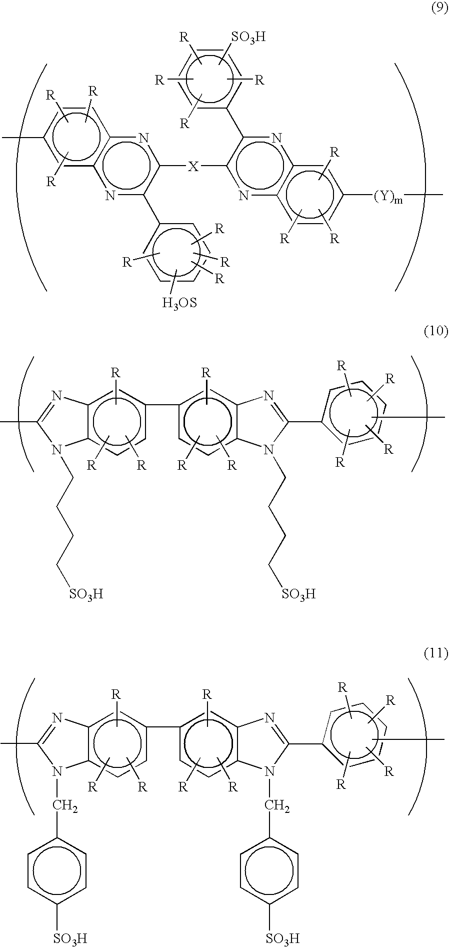

In these formulas, Rs independently represent a hydrogen atom, a hydroxyl group, an amino group, a nitro group, a phenyl group, a vinyl group, a halogen atom, an acyl group, a cyano group, a trifluoromethyl group, an alkoxyl group, a sulfonic acid group, a trifluoromethylthio group, a carboxyl group, a carboxylate group, a sulfonate group, an alkyl group having 1 to 20 carbon atoms optionally substituted with any of the above substituents, an alkenyl group having 2 to 20 carbon atoms optionally substituted with any of the above substituents, an aryl group having 6 to 20 carbon atoms optionally substituted with any of the above substituents or heterocyclic-compound residue; “X”s independently represent an optionally substituted arylene group; “Y”s independently represent a heteroatom, a sulfonyl group, a methylene group, an optionally substituted alkylene group having 2 to 20 carbon atoms or an optionally substituted arylene group having 6 to 20 carbon atoms; and “m”s independently represent an integer of 0 to 5.

The term “independently” in the definitions of X, Y or m, means that in each repeating unit, all of such a variable may be the same or different, and indicates that it is also independent in each structure in a polymer.

A heteroatom for Y in the above formulas may be an oxygen atom, a sulfur atom or a nitrogen atom. When it is a nitrogen atom, it may have, in addition to a linker, a hydrogen atom or a substituent such as an alkyl group having 1 to 10 carbon atoms.

Generally, a quinoxaline polymer can be prepared by polymerization of an aromatic tetramino compound represented by formula (12) and a tetracarbonyl compound represented by formula (13) as starting materials by a known process utilizing a dehydration reaction in an organic solvent (See, J. Polymer Science, Vol. 5, p. 1453, 1967).

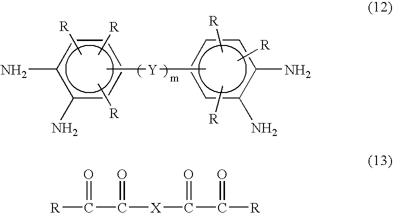

For example, a polymer having a unit represented by general formula (9) can be synthesized in accordance with the following reaction equation (14).

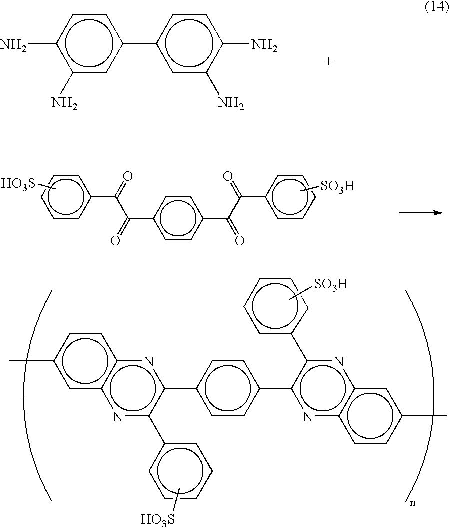

Although a compound in which one sulfonic acid group is directly attached to each end phenyl ring has been here used as a starting tetracarbonyl compound, a compound having a different number of sulfonic acid groups with a different binding style can be used to provide a quinoxaline polymer having a desired substituent with a sulfonic acid group and a desired sulfonation degree. For example, there may be provided a polymer where a sulfonic acid group is attached to a phenyl ring via an alkylene group having 1 to 20 carbon atoms (n: 1 to 20) as represented by general formula (15); a polymer where a sulfonic acid group is directly attached to a phenyl ring as represented by general formula (16); a polymer where a sulfonic acid group is attached to a phenyl ring via a ketone group as represented by general formula (17); and a polymer where a sulfonic acid group and an electron-withdrawing carboxyl group are attached to a phenyl ring as represented by general formula (18).

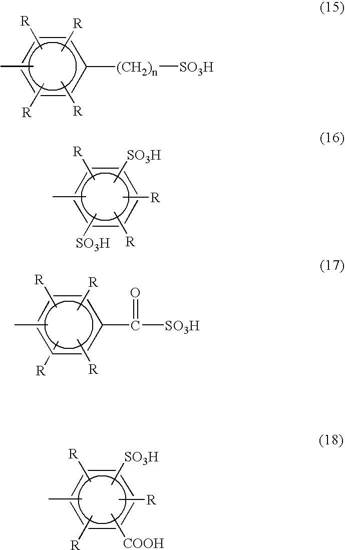

Next, there will be described a process for preparing a polymer having a unit represented by general formula (10).

A benzimidazole-based polymer can be synthesized by, for example, a known process shown in the following reaction equation (19). In the process, an aromatic tetramino compound represented by chemical formula (12) and an aromatic dicarbonyl compound represented by chemical formula (20), (21) or (22) can be used.

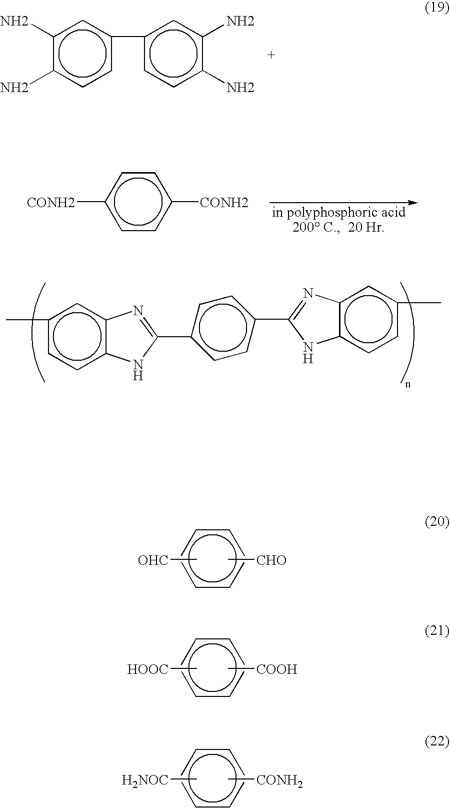

A benzimidazole-based polymer can be sulfonated by a process shown in reaction equations (23-a) or (23-b), to give a structure unit represented by general formula (10) or (11). “DMAc” in the equation denotes N,N-dimethylacetamide.

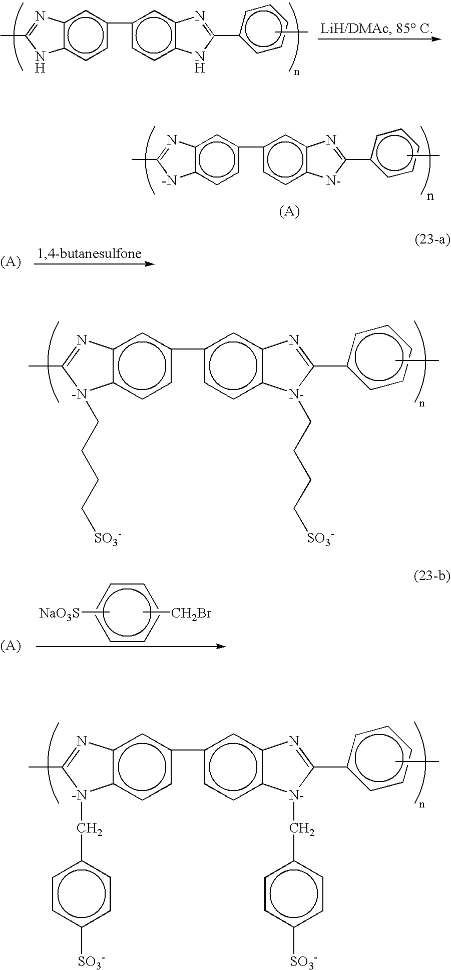

Although 1,4-butanesulfone or 4-bromo-methylbenzenesulfonate is used as a sulfonating agent in the equation, a sulfonating agent with a different carbon number and/or a different structure can be used to prepare a benzimidazole-based polymer comprising a sulfonic acid group-containing substituent with a desired structure.

Next, there will be a block copolymer (proton-conducting polymer) comprising a chain of units having a quinoxaline structure, a chain of units having the above imidazole structure and a proton-donating substituent attached to at least one of these units.

A specific example of such a polymer is a block copolymer of a chain comprising a unit of sulfonated 2,2′-(p-phenylene)-1-phenylquinoxaline represented by general formula (24) with a chain comprising a unit having a sulfonated benzimidazole structure.

After preparing sulfonated polymers constituting individual chains by the above synthetic process, the end groups in these polymers are activated and are treated with an appropriate compound capable of linking the activated polymer ends to provide a block copolymer compound. The procedure can be repeated to synthesize a copolymer compound having a desired block number.

Furthermore, a polymerization initiator such as a radical initiator or a nickel salt can be added to initiate polymerization of a monomer at a polymer end, in order to form a new polymerization chain. Alternatively, a block copolymer compound can be also prepared by conducting, in a solution of one polymer in a reaction solvent, a synthetic process for the other polymer to be copolymerized.

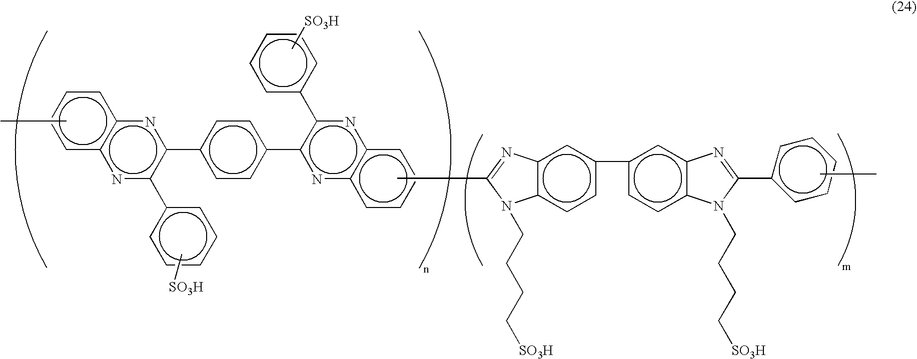

The above synthetic processes can be combined to form a copolymer with a graft structure having a branched structure or a copolymer having both a block structure and a branched structure, or to synthesize a proton-conducting polymer having a sulfonic acid group with an appropriate binding structure and/or an appropriate sulfonation degree.

Next, there will be described a polymer (proton-conducting polymer) comprising a unit having a quinoxaline structure and an imidazole structure. An example of such a polymer may be that comprising a repeating unit having a quinoxaline moiety and a benzimidazole moiety, represented by general formula (8):

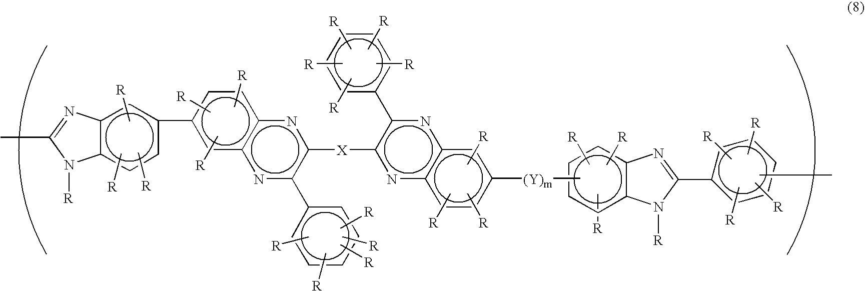

wherein at least one of Rs represents a proton-donating substituent and the remaining Rs independently represent a hydrogen atom, a hydroxyl group, an amino group, a nitro group, a phenyl group, a vinyl group, a halogen group, a acyl group, a cyano group, a trifluoromethyl group, an alkoxyl group, a sulfonic acid group, a trifluoromethylthio group, a carboxyl group, a carboxylate group, a sulfonate group, an alkyl group having 1 to 20 carbon atoms optionally substituted with any of the above substituents, an alkenyl group having 2 to 20 carbon atoms optionally substituted with any of the above substituents, an aryl group having 6 to 20 carbon atoms optionally substituted with any of the above substituents or a heterocyclic-compound residue; X represents an optionally substituted arylene group; “Y”s independently represent a heteroatom, a sulfonyl group, a methylene group, an optionally substituted alkylene group having 2 to 20 carbon atoms or an optionally substituted arylene group having 6 to 20 carbon atoms; and “m”s independently represent an integer of 0 to 5.

The term “independently” in the definitions of X, Y or m, means that in each repeating unit, all of such a variable may be the same or different, and indicates that it is also independent in each structure in a polymer.

A heteroatom for Y in the above formulas may be an oxygen atom, a sulfur atom or a nitrogen atom. When it is a nitrogen atom, it may have, in addition to a linker, a hydrogen atom or a substituent such as an alkyl group having 1 to 10 carbon atoms.

The above polymer can be synthesized in accordance with the following procedure.

A compound represented by general formula (12) or (13) as a starting material for a quinoxaline-based polymer and a compound represented by any of general formulas (20), (21) and (22) as a starting material for a benzimidazole-based polymer are subjected to a dehydration reaction in an organic solvent such as N,N-dimethylformamide (hereinafter, referred to as “DMF”) in accordance with the known process for preparing a quinoxaline-based polymer as described above. Specifically, a tetracarbonyl compound represented by general formula (13) (X: a p-phenylene group, R: a phenyl group having a sulfonic acid group) is dissolved in DMF and the mixture is stirred for 30 min. Then, to the solution is added a solution of 3,3′-diaminobenzidine and isophthalaldehyde in DMF, and the mixture is stirred at 120° C. for 10 hours in the atmospheric air. Thus, the reaction proceeds to provide the desired polymer. A polymerization temperature can be generally, but not limited to, approximately a reflux temperature of a solvent used. A reaction period can be determined as appropriate, depending on the type of monomers used and a solvent without any restriction. Since polymerization is associated with dehydrating condensation polymerization, a reaction time is preferably at least 10 hours. A polymerization solvent can be any of those which can easily dissolve starting compounds used and are inert to the starting compounds, without any restriction.

A sulfonic acid group (or a substituent having a sulfonic acid group) can be introduced into a polymer by forming a polymer using a starting material having a sulfonic acid group as described above or by forming a polymer before sulfonation with a sulfonating agent.

In terms of a proton-conducting polymer material in this invention, difference in a binding structure of a sulfonic acid group in a polymer (polymer compound) affects proton conductivity and durability, and a sulfonation degree of the polymer affects a degree of hydrophilicity to change, for example, its solubility in a solvent. It is, therefore, preferable to appropriately select a binding structure of a sulfonic acid group in the polymer and/or a sulfonation degree, depending on an application of the proton-conducting polymer material.

In an aqueous solution, a proton-conducting compound to which a sulfonic acid group is directly attached as shown in formula (16) is susceptible to elimination of sulfonic acid group by a hydrolysis reaction as shown in reaction equation (25). The phenomenon may also occur not only in an aqueous solution, but also due to a temperature difference in the atmospheric air, particularly under a high-temperature atmosphere. In contrast, elimination of sulfonic acid group can be avoided in, for example, a structure where a sulfonic acid group is attached via an alkylene bond such as methylene as shown in formula (15), or a structure where a sulfonic acid group-containing phenyl ring further has an electron-withdrawing substituent as shown in formula (18), resulting in reduction of an electron density in the phenyl ring.

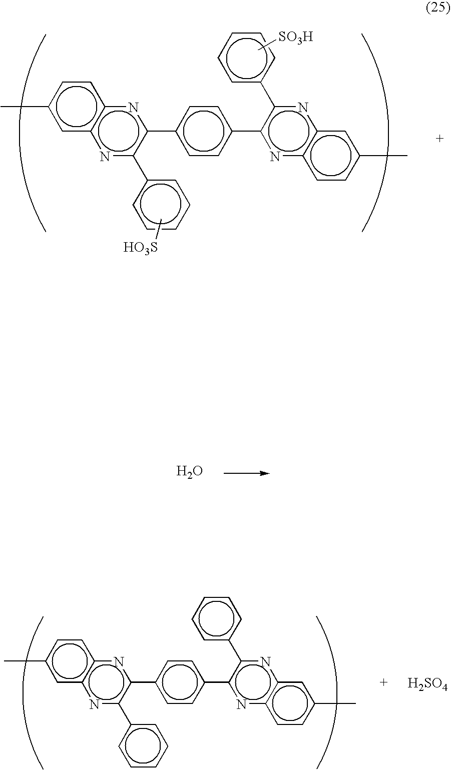

In a proton-conducting polymer material in this invention, a copolymerization composition of the polymer (polymer compound) can be controlled to an appropriate weight ratio by altering the charge amounts of starting compounds. Although there are no restrictions to a copolymerization composition, a copolymer with a proper composition is preferably used, depending on a range required for a target performance. For example, when the polymer is used as an electrode-active material in an electrochemical cell, a large redox capacity is required. It is, therefore, preferable that in an electrolytic solution containing a proton source, the polymer contains a large number of units of a proton-conducting compound with higher proton affinity. Here, a composition containing a large number of the quinoxaline-based compound unit is preferable. When being used as a solid electrolyte membrane, it desirably has a composition contributing to a higher ion conductivity, easier formation of the membrane and higher strength. For example, a molar ratio of the quinoxaline structure unit to the imidazole unit can be appropriately determined within the range of 1/9 to 9/1 or 2/8 to 8/2.

Although there are no restrictions to an ion conductivity (proton conductivity) of a solid electrolyte membrane according to this invention, it can be appropriately determined, depending on performance required for an electrochemical cell or fuel cell prepared using the solid electrolyte membrane. It may be generally 0.1 mS/cm or higher at 25° C., preferably 1 mS/cm or higher at the same temperature.

In a proton-conducting polymer material in this invention, there are no restrictions to a molecular weight of the polymer (polymer compound) as long as it is within a range where desired properties can be obtained, but the polymer may have, for example, a weight average molecular weight of about 500 to 100,000 as measured by GPC (gel permeation chromatography), preferably 5,000 to 100,000, more preferably about 5,000 to 80,000. When forming a solid electrolyte membrane, it is preferably 30,000 to 100,000, more preferably 35,000 to 80,000, further preferably 40,000 to 80,000 in the light of formability, a solubility in a solvent and strength of the membrane. It is further preferable to minimize the amount of a low molecular-weight compound as much as possible.

There are no restrictions to strength of a solid electrolyte membrane of this invention. However, in the light of handle properties when it is used in various electrochemical cells or fuel cells, its tensile strength is preferably 9.8 MPa (100 kg/cm²) or more, more preferably 29.4 MPa (300 kg/cm²) or more.

In this invention, an acidic compound in a proton-conducting polymer material may be any compound capable of discharge a proton, including inorganic compounds such as sulfonic acid-based compounds, carboxylic acid-based compounds and phosphoric acid-based compounds, organic compounds and polymer compounds, which can be used alone or in combination of two or more.

Specific examples of the compound include sulfuric acid, hydrochloric acid, nitric acid, acetic acid, boric acid, tetrafluoroboric acid, phosphoric acid, hexafluorophosphoric acid, propionic acid, fluoropropionic acid, butyric acid and fluorobutyric acid. Examples of an acidic polymer compound include polystyrenesulfonic acid, polyvinylsulfonic acid, phosphoric acid-based polymers and polyacrylic acid. Acidic monomer compounds can be used, including sulfonic acid-based monomers such as styrenesulfonic acid and vinylsulfonic acid; carboxylic acid-based monomers such as acrylic acid and methacrylic acid; and phosphoric acid-based monomers such as vinylphosphoric acid. Among these, sulfuric acid, sulfonic acid-based compounds, phosphoric acid-based compounds and their fluorides are preferable, and sulfuric acid, polystyrenesulfonic acid, polyvinylsulfonic acid and hexafluorophosphoric acid are particularly preferable.

Next, there will be described an electrochemical cell according to this invention.

An electrochemical cell of this invention is characterized in that it comprises an electrode comprising a proton-conducting polymer material of this invention as an active material, or that it comprises a solid electrolyte membrane consisting of a proton-conducting polymer material of this invention.

An electrochemical cell of this invention preferably comprises proton-conducting compounds as a cathode-active material and an anode-active material, and a proton-source containing electrolyte as an electrolyte. It preferably has a configuration that only protons can act as a charge carrier in a redox reaction associated with charge and discharge in both electrodes. Specifically, it preferably operates such that only adsorption and desorption of protons in the electrode-active materials can be involved in electron transfer in a redox reaction associated with charge and discharge in both electrodes.

There are no restrictions to a proton-conducting compound used as an electrode-active material as long as it is oxidative/reductive in a proton-source containing solution. Examples of a proton-conducting compound which can be used include polyaniline, polythiophene, polypyrrole, polyacetylene, poly-p-phenylene, polyphenylene-vinylene, polyperinaphthalene, polyfuran, polyflurane, polythienylene, polypyridinediyl, polyisothianaphthene, polyquinoxaline, polypyridine and polypyrimidine; indole-based polymers such as polyindole; π-conjugated polymers such as polyaminoanthraquinone, polyimidazole and their derivatives; indole π-conjugated compounds such as an indole trimer compound; quinone-based compounds such as benzoquinone, naphthoquinone and anthraquinone; quinone-based polymers such as polyanthraquinone, polynaphthoquinone and polybenzoquinone where a quinone oxygen can be converted into a hydroxyl group by conjugation; and proton-conducting polymer prepared by copolymerizing two or more of the monomers giving the above polymers. These compounds may be doped to form a redox pair for exhibiting conductivity. These compounds are appropriately selected as a cathode-active material and an anode-active material, taking a redox potential difference into account.

Here, there is illustrated an example where an indole-based compound (indole trimer compound) represented by general formula (26) is used as a cathode-active material and a polyphenyl quinoxaline or a proton-conducting polymer material represented by general formula (27) is used as an anode-active material.

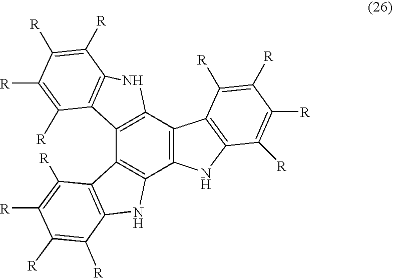

wherein Rs are independently represent a hydrogen atom, a hydroxyl group, a carboxyl group, a nitro group, a phenyl group, a vinyl group, a halogen atom, an acyl group, a cyano group, an amino group, a trifluoromethyl group, a sulfonic acid group, a trifluoromethylthio group, a carboxylate group, a sulfonate group, an alkoxyl group, an alkylthio group, an arylthio group, an alkyl group having 1 to 20 carbon atoms optionally substituted with any of these substituents, an aryl group having 6 to 20 carbon atoms optionally substituted with any of these substituents and a heterocyclic-compound residue.

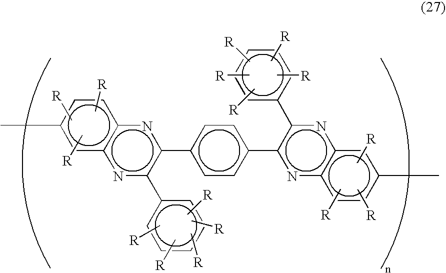

wherein Rs independently represent a hydrogen atom, a hydroxyl group, an amino group, a nitro group, a phenyl group, a vinyl group, a halogen atom, an acyl group, a cyano group, a trifluoromethyl group, an alkoxyl group, a sulfonic acid group, a trifluoromethylthio group, a carboxyl group, a carboxylate group, a sulfonate group, an alkyl group having 1 to 20 carbon atoms optionally substituted with any of the above substituents, an alkenyl group having 2 to 20 carbon atoms optionally substituted with any of the above substituents, an aryl group having 6 to 20 carbon atoms optionally substituted with any of the above substituents and a heterocyclic-compound residue.

FIG. 2 schematically illustrates a configuration of an electrochemical cell according to this invention.

On a cathode-current collector 1 and an anode-current collector 4 are formed a cathode 2 and an anode 3, respectively, which are disposed facing each other via a separator 5. Furthermore, the space is filled with an aqueous or non-aqueous solution containing a proton-source as an electrolytic solution and sealed by a gasket 6.

An electrode can be formed as follows.

An active material, a conductive auxiliary and if necessary a binder are blended. The conductive auxiliary can be added to 1 to 50 parts by weight, preferably 10 to 30 parts by weight to the active material. The binder can be added to 1 to 20 parts by weight, preferably 5 to 10 parts by weight to the active material. The mixed powder is placed in a mold with a given size and a given shape. It can be then pressed at an ambient temperature to 400° C., preferably 100 to 300° C., to form an electrode. Alternatively, to the mixture is added a solvent to prepare a slurry, which is then screen-printed on a conductive substrate. It can be dried to provide an electrode.

Examples of a conductive auxiliary which can be used include a fibrous carbon (trade name: VGCF, Showa Denko K.K.), a particulate carbon (trade name: Ketjen Black EC600JD, Ketjen Black International Company).

Examples of a binder which can be used include, but not limited to, polyvinylidene fluoride (PVDF) and polytetrafluoroethylene (PTFE).

An electrolytic solution may be a proton-containing aqueous or non-aqueous solution, including inorganic and organic acids. Examples of an inorganic acid include sulfuric acid, nitric acid, hydrochloric acid, phosphoric acid, tetrafluoroboric acid, hexafluorophosphoric acid and hexafluorosilic acid. Examples of an organic acid include saturated monocarboxylic acids, aliphatic carboxylic acids, oxycarboxylic acids, p-toluenesulfonic acid, polyvinylsulfonic acid and lauric acid. Among these, an acid-containing aqueous solution such as an aqueous sulfuric acid solution can be suitably used. The content of protons is preferably 10⁻³ moli or more, more preferably 10⁻¹ mol/l or more in the light of reactivity of an electrode material, while being preferably 18 mol/l or less, more preferably 7 mol/l or less in the light of prevention of activity reduction and elution of the electrode material.

There are no restrictions to a separator as long as it can electrically insulate both electrodes in an electrochemical cell. Examples include polyolefin porous membranes, ion-exchange membranes and a solid electrolyte membrane of this invention. A thickness of a solid electrolyte membrane is preferably, but not limited to, 10 to 200 μm, more preferably 10 to 80 μm.

An electrochemical cell of this invention may have a conventional external appearance such as, but not limited to, a coin and a laminate.

There will be described a fuel cell according to this invention.

A fuel cell of this invention is characterized in that it comprises a solid electrolyte membrane consisting of a proton-conducting polymer material of this invention.

FIG. 3 schematically illustrates a fuel cell of this invention.

This unit cell has, as a basic structure, a multilayer structure where are sequentially layered a fuel electrode separator 7, a fuel electrode catalyst layer 8 comprising a catalyst and a porous support, a proton-conducting solid electrolyte 9, an air electrode catalyst layer 10 comprising a catalyst and a porous support and an air electrode separator 11.

A separator is made of a conductive material for serially connecting unit cells, and is provided with an inlet or feeding channel for feeding a gas or a fuel to a catalyst layer. The conductive material may be suitably an acid-resistant conductive carbon material; specifically, a graphite sheet, a compound sheet of graphite and various resins and so on.

A catalyst layer may generally comprise a catalyst and a porous support. A catalyst can be a platinum catalyst, which is supported by a support such as a porous carbon. A suitable porous support is, for example, a carbon fiber sheet with good gas diffusivity. A catalyst layer is preferably adhesive to a solid electrolyte membrane in the light of battery properties. The adhesiveness can be improved by, for example, hot-pressing a solid electrolyte membrane at a temperature of its softening point or higher.

On both sides of the solid electrolyte membrane of this invention, are firmly attached an air electrode catalyst layer and a fuel electrode catalyst layer, to which are then layered an air electrode separator and a fuel electrode separator, respectively, to form a unit cell. If necessary, a plurality of unit cells can be serially connected into a package to provide a fuel cell.

The fuel cell obtained can operate by feeding a fuel such as hydrogen or methanol to the fuel electrode side while oxygen or the air to the air electrode side. Protons generated along with electrons in the fuel electrode are transferred through the solid electrolyte membrane to the air electrode side and then react with oxygen to form water.

The solid electrolyte membrane of this invention can be applied to, for example, an electrochromic device having a multilayer structure consisting of a transparent electrode, a color-changing electrode material layer, a proton-conducting solid electrolyte membrane, a counter electrode material layer and an electrode.

### EXAMPLES

This invention will be further specifically described with reference to Examples.

Identification of a Desired Compound after its Preparation

In terms of identification of a desired compound, a product was subjected to yield calculation and CHNS elementary analysis and IR spectrometry for determining its chemical structure and a sulfonation degree. A weight average molecular weight was determined by GPC (gel permeation chromatography) (J. Polymer Science, part B, Polymer Physics, Vol. 38, p. 1348, 2000; Chemistry Letters, p. 1049, 2000). An yield was calculated from a concentration difference between before and after charged starting materials. An yield of 96% or higher indicates that a target compound is substantially formed.

Determination of Strength of a Solid Electrolyte Membrane

Strength of a solid electrolyte membrane was determined by a tensile strength test.

A proton-conducting polymer was completely dissolved in an organic solvent. The solution was applied on a glass substrate using a screen printer. It was gradually warmed from an ambient temperature to be dried. After completely evaporating the solvent, a solid electrolyte membrane with a given film thickness was prepared.

One end of the resulting solid electrolyte membrane was fixed. To the membrane was gradually applied a load using a force gauge, and a value when breakage occurred was determined as a tensile strength.

Determination of an Ion Conductivity (Proton Conductivity)

An ion conductivity of a solid electrolyte membrane formed was determined by an alternating current impedance method. Specifically, a solid electrolyte membrane was sandwiched by platinum inert electrodes. To the membrane was then applied an alternating current in a 6M phosphoric acid solution at 25° C., to determine an impedance based on frequency properties.

Evaluation of Durability

Durability of a proton-conducting polymer prepared was evaluated by a CV cycle test using cyclic voltammetry (hereinafter, referred to as “CV” method).

The CV method was effected as follows. A test sample was prepared by mixing a proton-conducting polymer and carbon (a conductive auxiliary) in an appropriate weight ratio, dispersing the mixture in a solvent, applying the mixture on a conductive substrate and drying the substrate. An electrolytic solution was a 5 wt % aqueous sulfuric acid solution. A reference electrode was an Ag/AgCl electrode and a counter electrode was a Pt electrode. A 10,000 cycle test was conducted under the conditions of a sweep rate: 20 mV/sec, a sweep potential range: 0.5 V to −0.3 V and a measurement temperature: 60° C.

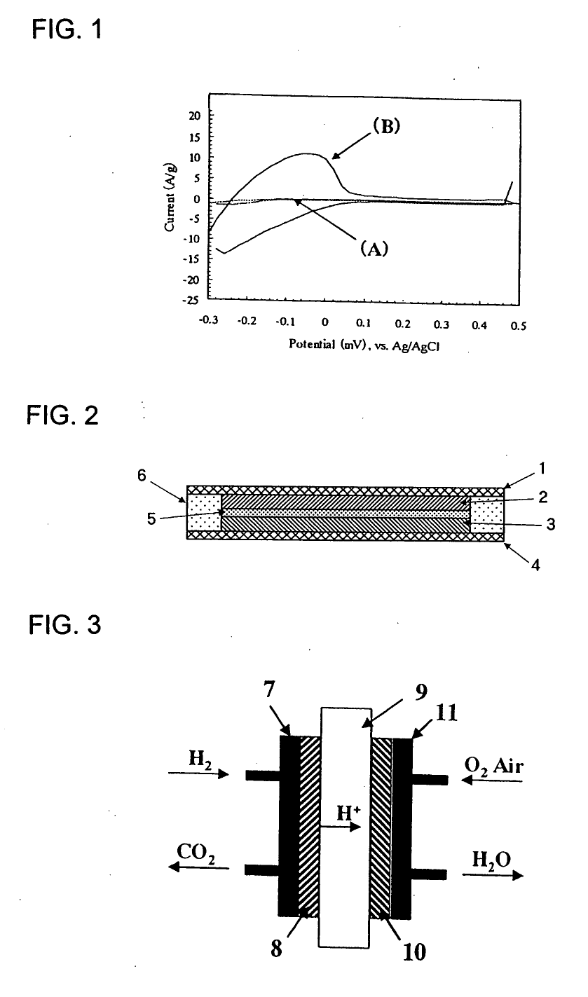

The 5 wt % aqueous sulfuric acid solution was used because of the following reason. A quinoxaline polymer is known as a basic polymer, and doped with protons by an acid-base reaction to form a redox pair, which contributes to conductivity expression, leading to a redox reaction. Electrochemical activity, therefore, substantially depends on a proton concentration. Specifically, when using an aqueous sulfuric acid solution as a proton source, a quinoxaline polymer exhibits the maximum redox activity at a proton concentration of about 40 wt %, while exhibiting extremely reduced activity at 10 wt % or less, so that a redox peak cannot be substantially observed. As a specific example, FIG. 1 shows cyclic voltammograms of an unsubstituted quinoxaline polymer (Sample A: Comparative Example 1 described later) and quinoxaline-benzimidazole copolymer having a sulfonic acid group (Sample B: Example 1 described later) in a 5 wt % aqueous sulfuric acid solution.

Thus, Sample (A) exhibited little activity while Sample (B) exhibited significant activity, probably because of difference in a proton conductivity due to the presence or absence of the sulfonic acid group and the presence or absence of the imidazole structure unit. A retention rate of the activity can be used as an indicator of functional durability by the sulfonic acid group and the imidazole structure unit. Here, a residual capacity rate was a proportion of a CV capacity after a 10,000 cycle test to an initial CV capacity. Residual capacity rate (%)=100×(CV capacity after 10,000 cycles)/(initial CV capacity).

### Example 1

A quinoxaline-benzimidazole polymer with a sulfonation degree 2 was prepared in accordance with reaction equation (28).

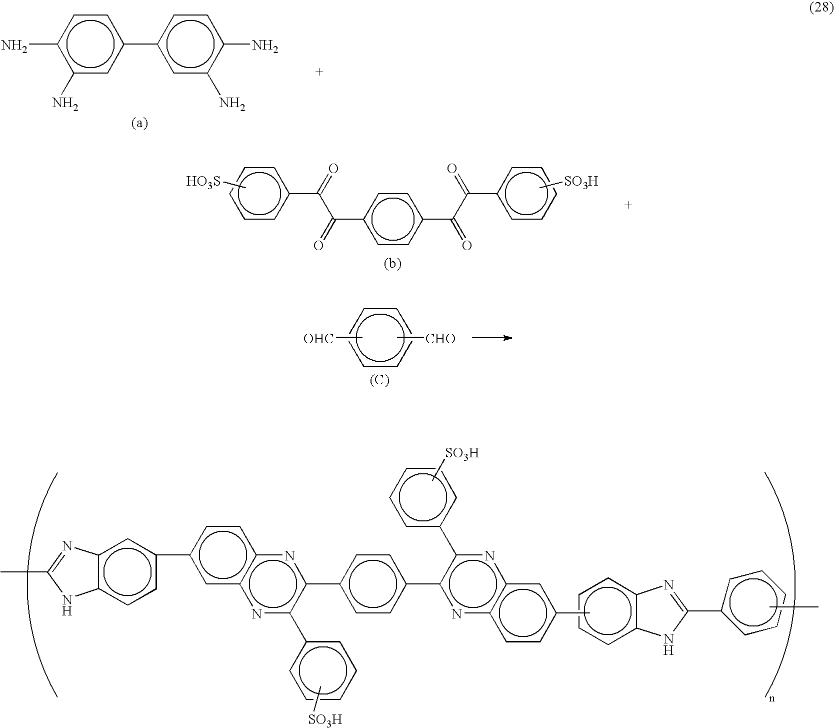

First, a sulfonated tetracarbonyl compound [b] was dissolved in DMF and the mixture was stirred for 30 min. Then, to the mixture was added a preformed solution of 3,3′-diaminobenzidine [a]and isophthalaldehyde [c] in DMF. Then, the mixture was stirred at 120° C. in the air for 10 hours for completing the reaction. The solid formed was collected by filtration and washed with methanol. After drying it in vacuo at 120° C. for 10 hours, a brown-yellow polymer was obtained.

As estimated from analytical values of concentrations before and after polymerization, an yield of the polymer obtained was 97.3%. CHNS elementary analysis values and an IR spectrum for the polymer indicated that it was a desired material. Its weight average molecular weight was 65,000 as determined by GPC.

A CV cycle test was conducted for the polymer obtained as follows.

The polymer and a particulate carbon (trade name: Ketjen Black EC600JD, Ketjen Black International Company) was sequentially mixed in a weight ratio of 7:3, and the mixture was dispersed in m-cresol. The mixture was applied on a conductive substrate, which was then dried at 120° C. to provide a measurement sample. The sample was subjected to a CV cycle test as described above. As a result, an initial CV capacity was 170 C/g and a residual capacity rate after 10,000 cycles was 41%.

### Example 2

A proton-conducting polymer powder prepared in Example 1 was completely dissolved in m-cresol, and the solution was applied on a glass substrate using a screen printer. Then, it was gradually warmed from an ambient temperature to 80° C. and finally dried at 120° C. for 1 hour for evaporating m-cresol to provide a brown-yellow solid electrolyte membrane with a thickness of 50 μm.

The membrane thus obtained had a tensile strength of 41.2 MPa (420 kg/cm²) and an ion conductivity (proton conductivity) of 0.53×10⁻² S/cm.

### Example 3

A proton-conductive compound, 6-(methyl carboxylate)-indole trimer as a cathode active material, a fibrous carbon (trade name: VGCF, Showa Denko, K. K.) as a conductive auxiliary and PVDF (average molecular weight: 1100) as a binder were sequentially weighed in a weight ratio of 69:23:8, and the mixture was mixed by stirring with a blender. Then, the mixed powder was placed in a mold with a size of 1 cm², and was pressed at 200° C. to provide a cathode.

An anode was prepared as described for the cathode, except that the proton-conducting polymer powder prepared in Example 1 and a particulate carbon (trade name: Ketjen Black EC600JD, Ketjen Black International Company) as a conductive auxiliary were sequentially mixed in a weight ratio of 75:25 and then the mixture was mixed by stirring with a blender.

An electrolytic solution was a 20 wt % aqueous sulfuric acid solution and a separator was a cation-exchange film with a thickness of 15 μm.

The cathode and the anode are laminated via the separator such that their electrode sides face each other. The assembly was packaged with a gasket to form a battery having a configuration shown in FIG. 2.

For the battery thus formed, a discharge capacity was measured 25 and −20° C. A charge condition was CCCV: 10 mA-1.2V for 10 min and a discharge condition was CC: 2 mA. A discharge capacity was 0.9 mAh at 25° C. and 0.63 mAh at −20° C. In addition, a discharge capacity at a discharge current of 100 mA was measured at 25° C. A measured discharge capacity was 0.57 mAh.

### Example 4

A battery was formed as described in Example 3, except that the solid electrolyte membrane with a thickness of 50 μm prepared in Example 2 was used as a separator and polyphenyl quinoxaline (a polymer represented by general formula (27) where all of Rs are H) was used as an anode-active material, and then a discharge capacity was determined for the battery.

A discharge capacity was 1.02 mAh at 25° C. and 0.58 mAh at −20° C. A discharge capacity at a discharge current of 100 mA was 0.46 mAh.

### Example 5

A multilayer structure for a fuel cell was prepared by disposing porous conductive carbon electrodes supporting a platinum catalyst, on both sides of the solid electrolyte membrane with a thickness of 50 μm prepared in Example 2 as usual. On both sides of the multilayer structure, a hydrogen feeding chamber and an air feeding chamber were provided to form a fuel cell.

While feeding hydrogen to the hydrogen electrode, an electromotive force was determined at 60° C. It was 0.61 V at 200 mA and 0.47 V at 1 A.

### Example 6

A quinoxaline-benzimidazole polymer having a sulfonation degree of 4 was prepared, which is represented by formula (29):

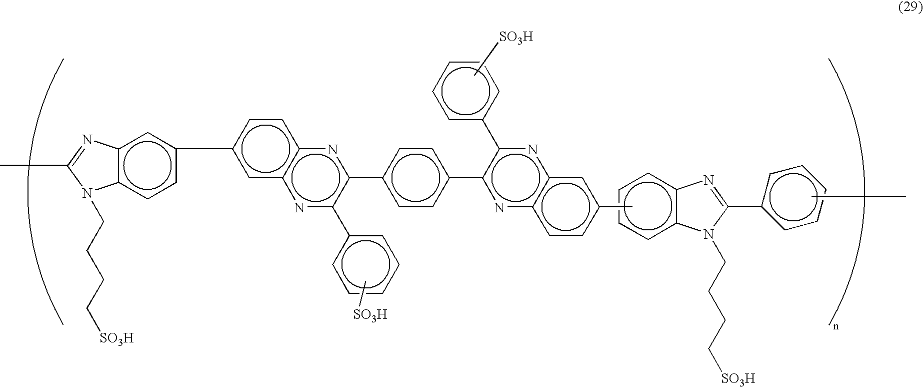

This polymer was prepared by preparing a polymer as described in Example 1 and then introducing a substituent having a sulfonic acid group at the N-position in the benzimidazole ring by the method illustrated in reaction equation (23-a).

The polymer was obtained in an yield of 97.2%. It was determined to be a desired substance by CHNS elementary analysis and IR spectrometry and has a weight average molecular weight of 72,000 as determined by GPC.

A CV cycle test was conducted as described in Example 1. As a result, an initial CV capacity was 254 C/g and a residual capacity rate after 10,000 cycles was 72%.

A solid electrolyte membrane was prepared and evaluated as described in Example 2. The membrane gave a tensile strength of 59.8 MPa (610 kg/cm²) and an ion conductivity of 0.82×10⁻² S/cm.

A battery was formed using the polymer as described in Example 3, and its discharge capacity was determined. A discharge capacity was 1.21 mAh at 25° C. and 1.04 mAh at −20° C. At 25° C., a discharge capacity at a discharge current of 100 mA was 0.97 mAh.

A fuel cell was formed using the membrane as described in Example 5, and its electromotive force was determined to be 0.71 V at 200 mA and 0.52 V at 1 A.

### Example 7

A quinoxaline-benzimidazole polymer with a sulfonation degree of 4 was prepared, which is represented by formula (30):

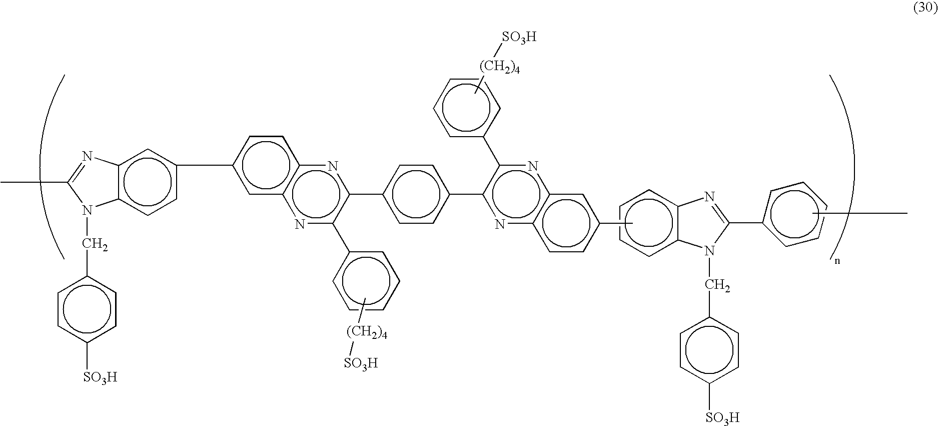

This polymer was prepared by preparing a polymer as described in Example 1 except that a sulfonated tetracarbonyl compound with a different binding structure of the sulfonic acid group and then introducing a substituent having a sulfonic acid group at the N-position in the benzimidazole ring by the process illustrated in reaction equation (23-b).

The polymer was obtained in an yield of 98.1%. It was determined to be a desired substance by CHNS elementary analysis and IR spectrometry and has a weight average molecular weight of 85,000 as determined by GPC.

A CV cycle test was conducted as described in Example 1. As a result, an initial CV capacity was 281 C/g and a residual capacity rate after 10,000 cycles was 73%.

A solid electrolyte membrane was prepared and evaluated as described in Example 2. The membrane gave a tensile strength of 71.6 MPa (730 kg/cm²) and an ion conductivity of 0.91×10⁻² S/cm.

A battery was formed using the polymer as described in Example 3, and its discharge capacity was determined. A discharge capacity was 1.41 mAh at 25° C. and 1.22 mAh at −20° C. At 25° C., a discharge capacity at a discharge current of 100 mA was 1.15 mAh.

A fuel cell was formed using the membrane as described in Example 5, and its electromotive force was determined to be 0.78 V at 200 mA and 0.66 V at 1 A.

### Example 8

A quinoxaline-benzimidazole block copolymer was prepared, which has a chain structure represented by formula (31):

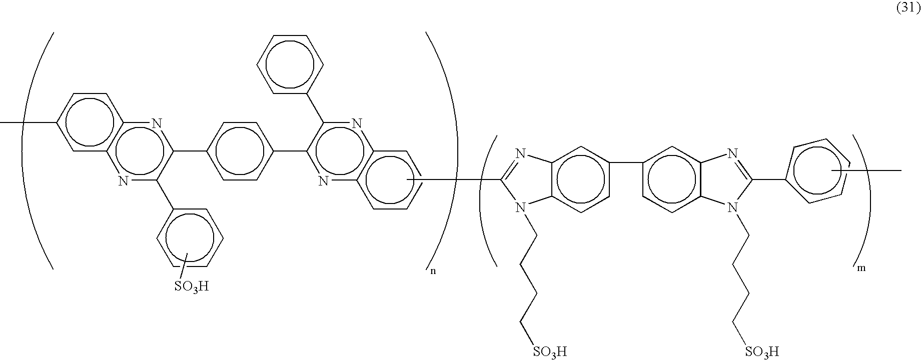

First, a polyphenyl quinoxaline with a sulfonation degree 1 (a sulfonated polymer represented by general formula (27) where all of Rs are H) was polymerized as usual, and then to the resulting polymer solution was added polymerization materials for forming a polybenzimidazole, to initiate polymerization (two-step polymerization). Next, a substituent having a sulfonic acid group was introduced at the N-position in the polybenzimidazole chain as illustrated in reaction equation (23-a).

Its CHNS elementary analysis value and IR spectrum indicated that it was a desired material. An yield was 97.9%. GPC indicated that a molecular weight distribution was homogeneous and that a weight average molecular weight was 75,000. It was determined to be a block copolymer with a weight ratio of a polyphenyl quinoxaline (PPQx) chain to a polybenzimidazole (PBI) chain (PBI/PPQx) of 0.7 from these analysis results and a charge composition of the starting materials.

A CV cycle test was conducted as described in Example 1. As a result, an initial CV capacity was 232 C/g and a residual capacity rate after 10,000 cycles was 75%.

A solid electrolyte membrane was prepared and evaluated as described in Example 2. The membrane gave a tensile strength of 74.5 MPa (760 kg/cm²) and an ion conductivity of 0.79×10⁻² S/cm.

A battery was formed using the polymer as described in Example 3, and its discharge capacity was determined. A discharge capacity was 0.81 mAh at 25° C. and 0.59 mAh at −20° C. At 25° C., a discharge capacity at a discharge current of 100 mA was 0.48 mAh.

A fuel cell was formed using the membrane as described in Example 5, and its electromotive force was determined to be 0.67 V at 200 mA and 0.53 V at 1 A.

### Example 9

A quinoxaline-benzimidazole graft polymer with a sulfonation degree of 2 was prepared, which is represented by formula (32):

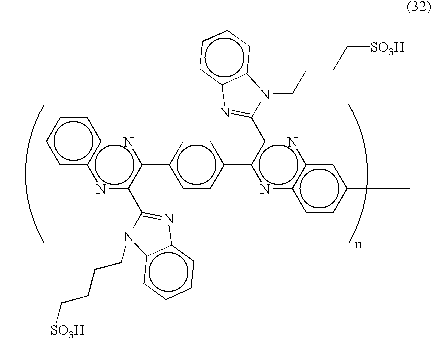

First, in DMF was dissolved a tetracarbonyl compound represented by formula (13) where X is a p-phenylene group and R is a 2-benzimidazolyl group), and the mixture was stirred for 30 min. Then, to the mixture was added a solution of 3,3′-diaminobenzidine in DMF. Next, the mixture was stirred in the atmospheric air at 120° C. for 10 hours for completing the reaction. The resulting solid was collected by filtration, washed with methanol, and dried in vacuo at 120° C. for 10 hours to provide a brown-yellow polymer. Subsequently, a substituent having a sulfonic acid group was introduced at the N-position in the benzimidazole ring according to the process illustrated in reaction equation (23-a).

The polymer was obtained in an yield of 96.2%. It was determined to be a desired substance by CHNS elementary analysis and IR spectrometry and has a weight average molecular weight of 41,000 as determined by GPC.

A CV cycle test was conducted as described in Example 1. As a result, an initial CV capacity was 271 C/g and a residual capacity rate after 10,000 cycles was 84%.

A solid electrolyte membrane was prepared and evaluated as described in Example 2. The membrane gave a tensile strength of 32.4 MPa (330 kg/cm²) and an ion conductivity of 0.86×10⁻² S/cm.

A battery was formed using the polymer as described in Example 3, and its discharge capacity was determined. A discharge capacity was 1.16 mAh at 25° C. and 1.04 mAh at −20° C. At 25° C., a discharge capacity at a discharge current of 100 mA was 0.89 mAh.

A fuel cell was formed using the membrane as described in Example 5, and its electromotive force was determined to be 0.71 V at 200 mA and 0.59 V at 1 A.

### Example 10

The solid electrolyte membrane prepared in Example 2 was doped with sulfuric acid by immersing the membrane in a 60 wt % sulfuric acid aqueous solution at an ambient temperature for 24 hours. At the end of the immersion, the membrane was discolored from brown-yellow to red, indicating successful doping with sulfuric acid.

The solid electrolyte membrane had a tensile strength of 34.3 MPa (350 kg/cm²) and an ion conductivity of 0.59×10⁻² S/cm.

A fuel cell was formed as described in Example 5, except that this solid electrolyte membrane was used. While feeding hydrogen to the hydrogen electrode, an electromotive force was determined at 60° C. It was 0.65 V at 200 mA and 0.51 V at 1 A.

### Example 11

The solid electrolyte membrane prepared in Example 2 was doped with polystyrenesulfonic acid by immersing the membrane in a 30 wt % polystyrenesulfonic acid aqueous solution at an ambient temperature for 24 hours. At the end of the immersion, the membrane was discolored from brown-yellow to light red, indicating successful doping with polystyrenesulfonic acid.

The solid electrolyte membrane had a tensile strength of 38.2 MPa (390 kg/cm²) and an ion conductivity of 0.55×10⁻² S/cm.

### Example 12

In accordance with a common process illustrated in reaction equation (14), a polyphenyl quinoxaline with a sulfonation degree of 2 was prepared. The polymer was obtained in an yield of 92.4%. It was determined to be a desired substance by CHNS elementary analysis and IR spectrometry and has a weight average molecular weight of 11,000 as determined by GPC.

Separately, in accordance with a common process illustrated in reaction equations (19) and (23-a), a polybenzimidazole with a sulfonation degree 2 was prepared. The polymer was obtained in an yield of 98.6%. It was determined to be a desired substance by CHNS elementary analysis and IR spectrometry and has a weight average molecular weight of 84,000 as determined by GPC.

These polymers are blended in a weight ratio of 5:5, and dry mixed using a high-speed blender (30 sec×3) to prepare a proton-conducting polymer material.

A CV cycle test was conducted as described in Example 1. As a result, an initial CV capacity was 186 C/g and a residual capacity rate after 10,000 cycles was 61%.

A solid electrolyte membrane was prepared and evaluated as described in Example 2. The membrane gave a tensile strength of 30.4 MPa (310 kg/cm²) and an ion conductivity of 0.65×10⁻² S/cm.

A battery was formed using the polymer material as described in Example 3, and its discharge capacity was determined. A discharge capacity was 0.58 mAh at 25° C. and 0.32 mAh at −20° C. At 25° C., a discharge capacity at a discharge current of 100 mA was 0.27 mAh.

A fuel cell was formed using the membrane as described in Example 5, and its electromotive force was determined to be 0.57 V at 200 mA and 0.43 V at 1 A.

### Example 13

An unsubstituted polyphenyl quinoxaline (the polymer represented by general formula (27) where all of Rs are H) was prepared as usual. Specifically, a tetracarbonyl compound and 3,3′-diaminobenzidine were dissolved in DMF. The solution was stirred for 30 min and then at 120° C. for 10 hours in the atmospheric air for completing the reaction. The resulting yellow solid was collected by filtration, washed with methanol and then dried in vacuo at 120° C. for 10 hours, to provide a polymer with an yield of 99.4%. It was determined to be a desired substance by CHNS elementary analysis and IR spectrometry and has a weight average molecular weight of 45,000 as determined by GPC.

Separately, in accordance with a common process illustrated in reaction equations (19) and (23-a), a polybenzimidazole with a sulfonation degree 2 was prepared. The polymer was obtained in an yield of 98.6%. It was determined to be a desired substance by CHNS elementary analysis and IR spectrometry and has a weight average molecular weight of 84,000 as determined by GPC.

These polymers are blended in a weight ratio of 6:4 in the order, and dry mixed using a high-speed blender (30 sec×3) to prepare a proton-conducting polymer material.

A CV cycle test was conducted as described in Example 1. As a result, an initial CV capacity was 78 C/g and a residual capacity rate after 10,000 cycles was 81%.

A solid electrolyte membrane was prepared and evaluated as described in Example 2. The membrane gave a tensile strength of 47.1 MPa (480 kg/cm²) and an ion conductivity of 0.43×10⁻² S/cm.

A battery was formed using the polymer material as described in Example 3, and its discharge capacity was determined. A discharge capacity was 0.39 mAh at 25° C. and 0.31 mAh at −20° C. At 25° C., a discharge capacity at a discharge current of 100 mA was 0.28 mAh.

A fuel cell was formed using the membrane as described in Example 5, and its electromotive force was determined to be 0.59 V at 200 mA and 0.48 V at 1 A.

### Comparative Example 1

As described in Example 13, an unsubstituted polyphenyl quinoxaline (a polymer represented by general formula (27) where all of Rs are H) was prepared with an yield of 99.4%. It was determined to be a desired substance by CHNS elementary analysis and IR spectrometry and has a weight average molecular weight of 45,000 as determined by GPC.

A CV cycle test was conducted as described in Example 1. As a result, an initial CV capacity was 5.3 C/g, which indicated quite poor activity.

A solid electrolyte membrane was prepared and evaluated as described in Example 2. The membrane gave a tensile strength of 54.9 MPa (560 kg/cm²) and an ion conductivity of 3.4×10⁻² S/cm.

The solid electrolyte membrane was doped with sulfuric acid by immersing the membrane in a 60 wt % sulfuric acid solution at an ambient temperature for 24 hours. At the end of the immersion, the membrane was discolored from yellow to red, indicating completion of doping with sulfuric acid.

### Comparative Example 2

In accordance with a common process illustrated in reaction equation (14), a polyphenyl quinoxaline with a sulfonation degree of 2 was prepared. Specifically, a sulfonated tetracarbonyl compound and 3,3′-diaminobenzidine were dissolved in DMF. The solution was stirred for 30 min and then at 120° C. for 10 hours in the atmospheric air for completing the reaction. The resulting yellow solid was collected by filtration, washed with methanol and then dried in vacuo at 120° C. for 10 hours, to provide a polymer with an yield of 92.4%. It was determined to be a desired substance by CHNS elementary analysis and IR spectrometry and has a weight average molecular weight of 11,000 as determined by GPC.

A CV cycle test was conducted as described in Example 1. As a result, an initial CV capacity was 150 C/g and a residual capacity rate after 10,000 cycles was 19%.

Although preparation of a solid electrolyte membrane was attempted as described in Example 2, a membrane could not be formed. Thus, an ion conductivity could not be determined.

A battery was formed using the polymer as described in Example 3, and its discharge capacity was determined. A discharge capacity was 0.71 mAh at 25° C. and 0.49 mAh at −20° C. At 25° C., a discharge capacity at a discharge current of 100 mA was 0.38 mAh.

### Comparative Example 3

A quinoxaline-benzimidazole polymer without a sulfonic acid group was prepared with an yield of 98.1% as described in Example 1, except that a tetracarbonyl compound without a sulfonic acid group was used. It was determined to be a desired substance by CHNS elementary analysis and IR spectrometry and has a weight average molecular weight of 64,000 as determined by GPC.

A CV cycle test was conducted as described in Example 1. As a result, an initial CV capacity was 8.7 C/g, which indicated quite poor activity.

A solid electrolyte membrane was prepared and evaluated as described in Example 2. The membrane gave a tensile strength of 66.7 MPa (680 kg/cm²) and an ion conductivity of 7.1×10⁻² S/cm.

What is claimed is:

1. A proton-conducting polymer material comprising a quinoxaline-based compound structure, an imidazole-based compound structure and a proton-donating substituent.

2. The proton-conducting polymer material as claimed in claim 1, wherein the quinoxaline-based compound structure is a quinoxaline structure represented by general formula (1): 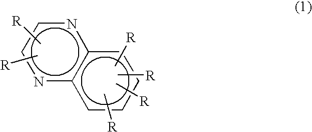
wherein at least one of Rs is attached to a principal chain or a side chain or at least two of Rs forms the principal chain, and the remaining Rs independently represent the proton-donating substituent, a hydrogen atom, a hydroxyl group, an amino group, a nitro group, a phenyl group, a vinyl group, a halogen atom, an acyl group, a cyano group, a trifluoromethyl group, an alkoxyl group, a sulfonic acid group, a trifluoromethylthio group, a carboxyl group, a carboxylate group, a sulfonate group, an alkyl group having 1 to 20 carbon atoms optionally substituted with any of the above substituents, an alkenyl group having 2 to 20 carbon atoms optionally substituted with any of the above substituents, an aryl group having 6 to 20 carbon atoms optionally substituted with any of the above substituents or a heterocyclic-compound residue.

3. The proton-conducting polymer material as claimed in claim 1, wherein the quinoxaline-based compound structure is a quinoxaline structure unit represented by general formula (2): 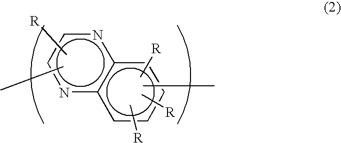
wherein Rs independently represent the above proton-donating substituent, a hydrogen atom, a hydroxyl group, an amino group, a nitro group, a phenyl group, a vinyl group, a halogen atom, an acyl group, a cyano group, a trifluoromethyl group, an alkoxyl group, a sulfonic acid group, a trifluoromethylthio group, a carboxyl group, a carboxylate group, a sulfonate group, an alkyl group having 1 to 20 carbon atoms optionally substituted with any of the above substituents, an alkenyl having 2 to 20 carbon atoms optionally substituted with any of the above substituents, an aryl group having 6 to 20 carbon atoms optionally substituted with any of the above substituents or a heterocyclic-compound residue.

4. The proton-conducting polymer material as claimed in claim 1, comprising a polymer which comprises a unit having the quinoxaline-based compound structure, a unit having the imidazole-based compound structure, and a proton-donating substituent attached to at least one of these units as the proton-donating substituent where a quinoxaline fused ring in the quinoxaline-based compound structure is a constituent of a principal chain of the polymer.

5. The proton-conducting polymer material as claimed in claim 4, wherein the proton-donating substituent is at least attached to an imidazole ring nitrogen in the imidazole-based compound structure.

6. The proton-conducting polymer material as claimed in claim 1, comprising a block copolymer which comprises a chain of units having the quinoxaline-based compound structure, a chain of units having the imidazole-based compound structure and a proton-donating substituent attached to at least one of these units as the proton-donating substituent.

7. The proton-conducting polymer material as claimed in claim 1, comprising a polymer where the imidazole-based compound structure or a side chain having the imidazole-based compound structure is attached to the principal chain having a unit having the quinoxaline-based compound structure.

8. The proton-conducting polymer material as claimed in claim 1, comprising a polymer which comprises a unit having the quinoxaline-based compound structure, a polymer which comprises a unit having the imidazole-based compound structure and a proton-donating substituent attached to at least one of these polymers as the proton-donating substituent.

9. The proton-conducting polymer material as claimed in claim 1, wherein the imidazole-based compound structure has a benzimidazole or benzobisimidazole moiety.

10. The proton-conducting polymer material as claimed in claim 1, wherein the imidazole-based compound structure comprises at least one selected from the group consisting of a unit having a benzimidazole moiety represented by one of general formulas (3) to (5), a unit having a benzobisimidazole moiety represented by (6) and a vinylimidazole unit represented by general formula (7): 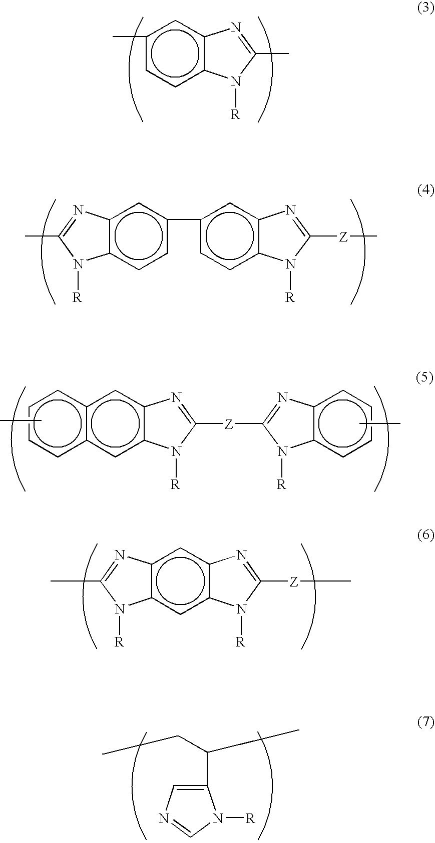
wherein Rs independently represent the above proton-donating substituent, a hydrogen atom, a hydroxyl group, an amino group, a nitro group, a phenyl group, a vinyl group, a halogen atom, an acyl group, a cyano group, a trifluoromethyl group, an alkoxyl group, a sulfonic acid group, a trifluoromethylthio group, a carboxyl group, a carboxylate group, a sulfonate group, an alkyl group having 1 to 20 carbon atoms optionally substituted with any of the above substituents, an alkenyl group having 2 to 20 carbon atoms optionally substituted with any of the above substituents, an aryl group having 6 to 20 carbon atoms optionally substituted with any of the above substituents or a heterocyclic-compound residue; and Z represents an arylene group optionally substituted with any of the above substituents.

11. The proton-conducting polymer material as claimed in claim 1, comprising a polymer which comprises a unit having a quinoxaline structure, an imidazole structure and a proton-donating substituent, represented by general formula (8): 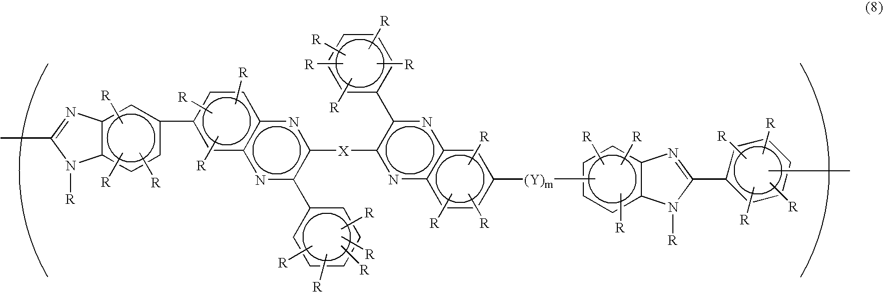
wherein at least one of Rs represents a proton-donating substituent and the remaining Rs independently represent a hydrogen atom, a hydroxyl group, an amino group, a nitro group, a phenyl group, a vinyl group, a halogen atom, a acyl group, a cyano group, a trifluoromethyl group, an alkoxyl group, a sulfonic acid group, a trifluoromethylthio group, a carboxyl group, a carboxylate group, a sulfonate group, an alkyl group having 1 to 20 carbon atoms optionally substituted with any of the above substituents, an alkenyl group having 2 to 20 carbon atoms optionally substituted with any of the above substituents, an aryl group having 6 to 20 carbon atoms optionally substituted with any of the above substituents or a heterocyclic-compound residue; X represents an optionally substituted arylene group; Ys independently represent a heteroatom, a sulfonyl group, a methylene group, an optionally substituted alkylene group having 2 to 20 carbon atoms or an optionally substituted arylene group having 6 to 20 carbon atoms; and m represents an integer of 0 to 5.

12. The proton-conducting polymer material as claimed in claim 1, wherein the proton-donating substituent is a sulfonic acid group or a substituent having a sulfonic acid group.

13. An electrode-active material comprising the proton-conducting polymer material as claimed in claim 1.

14. A solid electrolyte comprising the proton-conducting polymer material as claimed in claim 1.

15. The solid electrolyte as claimed in claim 14, further comprising an acidic compound.

16. The solid electrolyte as claimed in claim 15, wherein the acidic compound is at least one selected from the group consisting of sulfuric acid, hydrochloric acid, nitric acid, acetic acid, boric acid, tetrafluoroboric acid, phosphoric acid, hexafluorophosphoric acid, propionic acid, fluoropropionic acid, butyric acid and fluorobutyric acid.

17. The solid electrolyte as claimed in claim 15, wherein the acidic compound is at least one selected from the group consisting of a monomer of sulfonic acid-based compound, a monomer of carboxylic acid-based compound and a monomer of phosphoric acid-based compound and polymers of the monomers.

18. A solid electrolyte membrane consisting of the solid electrolyte as claimed in claim 14.

19. The solid electrolyte membrane as claimed in claim 18, wherein its thickness is 10 to 200 μm.

20. An electrochemical cell comprising the proton-conducting polymer material as claimed in claim 1 as an electrode-active material.

21. An electrochemical cell comprising a pair of electrodes and the solid electrolyte membrane as claimed in claim 18 sandwiched between these electrodes.

22. The electrochemical cell as claimed in claim 20, wherein the electrolyte contains a proton source and the electrochemical cell can operate such that protons alone act as a charge carrier in a redox reaction associated with charge/discharge.

23. The electrochemical cell as claimed in claim 21, wherein the electrolyte contains a proton source and the electrochemical cell can operate such that protons alone act as a charge carrier in a redox reaction associated with charge/discharge.

24. A fuel cell comprising a fuel electrode, an air electrode and the solid electrolyte membrane as claimed in claim 18 between the electrodes.
